(19) United States
(12) Patent Application Publication
(10) Pub. No.: US 2015/0377455 A1
(43) Pub. Date: Dec. 31, 2015

(54) Back-Lighted Twinkling Candle

(71) Applicant: Chin-Sheng Yang, Tainan City (TW)

(72) Inventor: Chin-Sheng Yang, Tainan City (TW)

(21) Appl. No.: 14/318,698

(22) Filed: Jun. 30, 2014

(51) Int. Cl. F21V 14/00; F21V 23/00; F21V 8/00

(52) U.S. Cl. CPC F21V 14/006; G02B 6/0075; F21V 23/007; F21Y 2101/02

(57) ABSTRACT

A back-lighted twinkling candle mainly includes a main body, base seat and graph card unit. The main body is hollow and pervious-to-light, inside which flowable fluid and a poking member are mounted hermetically, and one side thereof has a planar surface portion; the base seat is configured below the main body, configured with a control circuit and at least one light-emitting element in electric connection with the control circuit correspondingly to the bottom of the main body, and has a magnetic rotating shaft driven by a power member to rotate, the poking member being attracted by the magnetic rotating shaft magnetically to rotate; the graph card unit includes a pervious-to-light first guiding sheet stacked on the planar surface portion, the first light guiding sheet having a preset texture and a light guiding portion corresponding to the light-emitting element. Whereby, light emitted from the light-emitting element is scattered in the first light guiding sheet through the light guiding portion, allowing the preset texture to be more bright and dazzling, and at the same time, the poking member is attracted magnetically to rotate to stir the inside fluid to flow, allowing the present invention to have a decoration profiting effect.

### TECHNICAL FIELD OF THE INVENTION

The present invention relates to a candle, and more particularly to an electronic candle design used for a visual decoration object in an environmental space.

### DESCRIPTION OF THE PRIOR ART

Recently, environmental awareness cause the use of traditional candles to be called in question such that substitutive simulative candles capable of using repeatedly, yielding no pollution and achieving a candlelight effect are valued gradually. Currently, a variety of electronic candles are available in the customer market, but they usually are only simple illuminative bodies with a candle outlook, and simply provide illumination. Therefore, such kinds of electronic candles are not eye-appealing, interesting and difficult to create the atmosphere.

### SUMMARY OF THE INVENTION

The main object of the present invention is to provide a back-lighted twinkling candle, capable of solving the deficiencies of lacking of interest and being difficult to creating the atmosphere with respect to conventional electronic candles.

To achieve the object mentioned above, the present invention proposes a back-lighted twinkling candle, mainly including:

a main body, being hollow and pervious-to-light, flowable fluid and a poking member being mounted inside the main body hermetically, and one side of the main body having a planar surface portion;

a base seat, configured below the main body, configured with a control circuit and at least on light-emitting element in electric connect with the control circuit correspondingly to a bottom of the main body, and a magnetic rotating shaft driven by a power member to rotate, the magnetic rotating shaft attracting the poking member magnetically to rotate; and

a graph card unit, including a pervious-to-light first light guiding sheet stacked on the planar surface portion of the main body, the first guiding sheet having a preset texture, a light guiding portion corresponding to the light-emitting element.

Whereby, light emitted from the light-emitting element is scattered in the first light guiding sheet through the light guiding portion, allowing the preset texture to be more bright and dazzling, and at the same time, the poking member is attracted magnetically to rotate to stir the inside fluid to flow, allowing the present invention to have a decoration profiting effect.

### BRIEF DESCRIPTION OF THE DRAWINGS

FIG. 1 is an exploded view of the present invention;

FIG. 2 is a perspective view of the present invention;

FIG. 3 is a cross sectional view of the present invention;

FIG. 3a is a partly enlarged view of FIG. 3;

FIG. 4 is a cross sectional view of the present invention;

FIG. 4a is a partly enlarged view of FIG. 4;

FIG. 5 is an exploded view of a preferred embodiment according to the present invention;

FIG. 6 is a perspective view of the embodiment according to the present invention; and

FIG. 7 is a partly cross-sectional view of the embodiment according to the present invention.

### DETAILED DESCRIPTION OF THE PREFERRED EMBODIMENTS

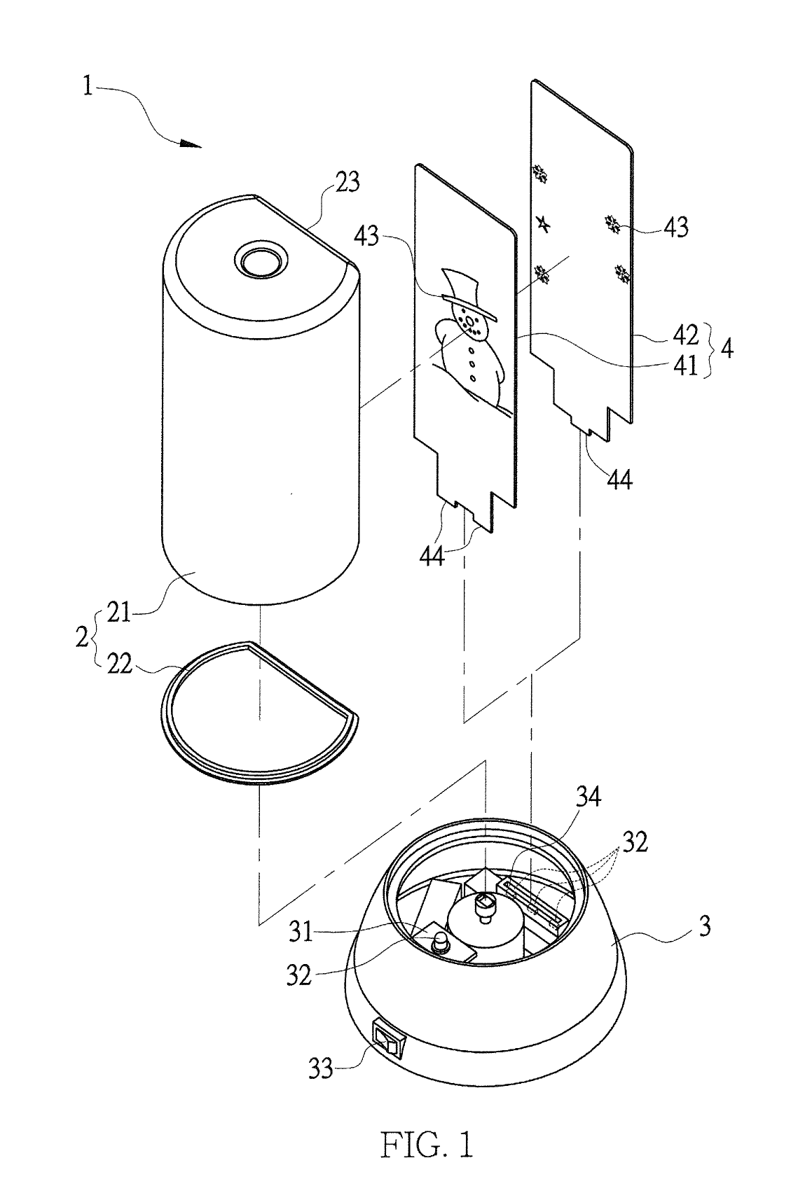

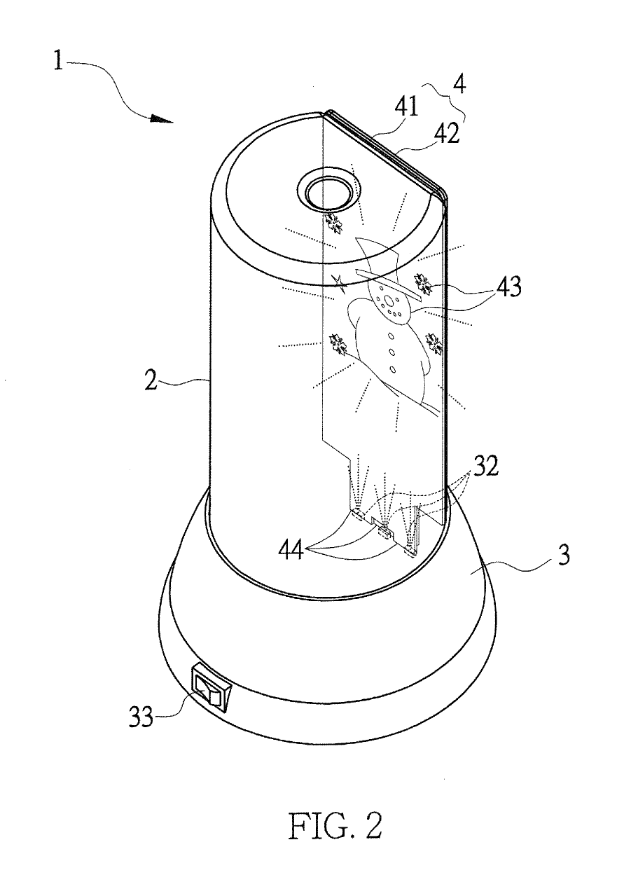

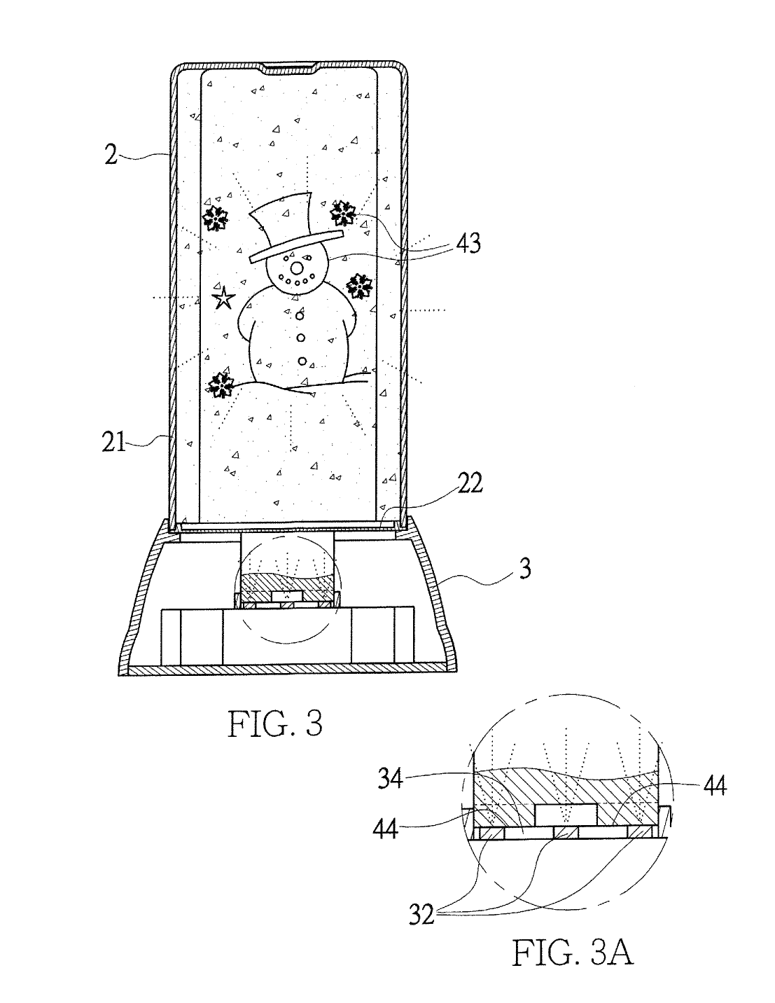

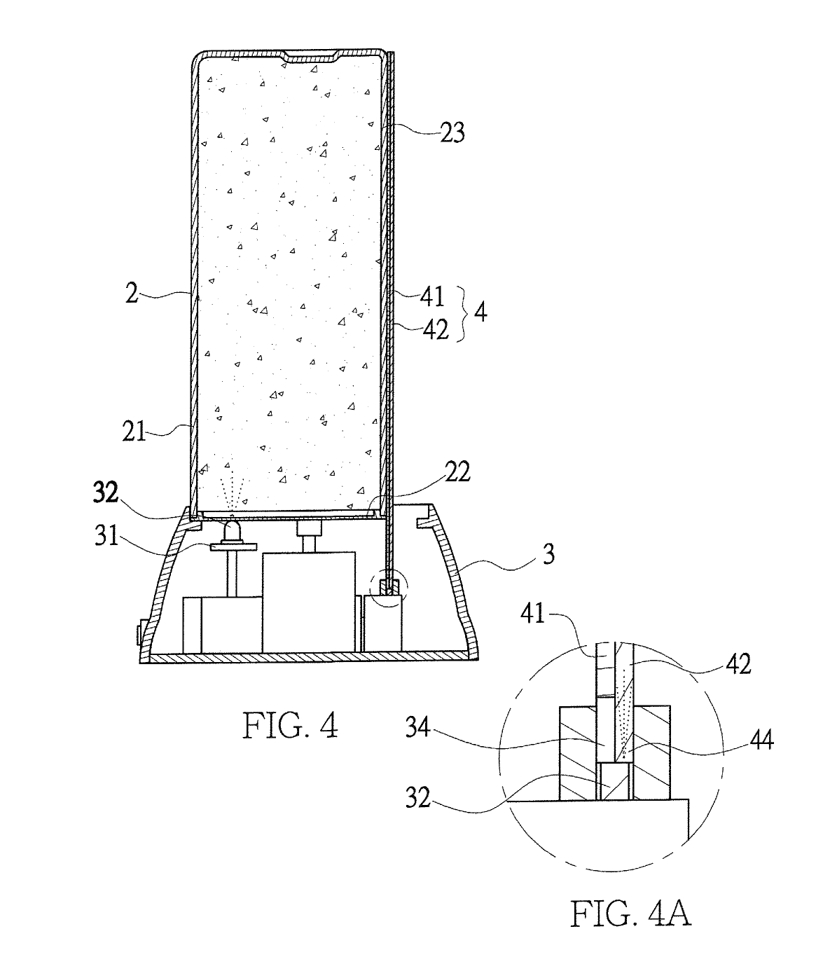

Referring to FIGS. 1 to 4a, which respectively are a exploded view, perspective view, cross-sectional view, and cross-sectional view of a preferred embodiment of a back-lighted twinkling candle according to the present invention, the back-lighted twinkling candle 1 mainly includes a main body 2, a base seat 3 and a graph card unit 4, where the main body 2 is configured above the base seat 3, and the graph card unit 4 on one side of the main body 2.

The main body 2 is constituted by a hollow, pervious-to-light shell 21, a pervious-to-light bottom cover 22, where flowable fluid is shielded and paillette or glitter powder is filled inside the main body 2, and a planar surface portion 23 is configured on one side of the main body 2.

The base seat 3 is configured below the main body 2, and a control circuit 31, light-emitting elements 32 and a switch 33 thereof are configured correspondingly to the bottom of the main body 2, where the light-emitting elements 32 and switch 33 are in electric connection with the control circuit 3. in the present embodiment, for example, the light-emitting elements 32 are LEDs(light emitting diodes) and the number thereof is more than one. Furthermore, a slot 34 is configured on the base seat 3 correspondingly to the lower side of the planar surface portion 23 on the bottom of which the three light-emitting elements 32 spaced apart are configured. The twinkling frequencies and light color changes of these light-emitting elements 32 are controlled by the control circuit 31, and the slot 34 is mainly used for light concentration. In addition, a light-emitting element 32 is further configured correspondingly to the main body 2 according to the present invention, adapted for the illumination of the fluid inside the main body.

The graph card unit 4 includes a pervious-to-light first light guiding sheet 41 and second light guiding sheet 42, where the first and second guiding sheets 41, 42 are overlaid to attach to each other, and respectively have a preset texture 43 and light input portion 44; the two textures 43 are interlocked, and the light input portions 44 are staggered, each of which corresponds to the respective light-emitting element 32, causing each light input portion 44 to illuminate and twinkle independently, thereby allowing the textures 43 of the first light guiding sheet 41 and second light guiding sheet 42 to display a visually dynamic effect. In the present embodiment, the first light guiding sheet 41 is stacked on the outer side of the planar surface portion 23 of the main body 2.

As mentioned above, the graph card unit 4 may also be stacked on the inner side of the plan portion 23, i.e., configured inside the main body 2, and each light input portion 44 is then attached to the bottom cover 22. Furthermore, each light-emitting element 32 is then configured under the respective light input portion 44 correspondingly, and in contact with the bottom cover 22, allowing light to be incident normally into each light input portion 44 and scattered in the first light guiding sheet 41 and second light guiding sheet 42.

Whereby, when the base seat 3 is switched on, the light emitted from the light-emitting elements 3 is scattered in the first and second light guiding sheets 41, 42 through the light input portions 44, allowing the preset textures 43 to be more bright and dazzling, allowing the present invention to have a decoration profiting effect.

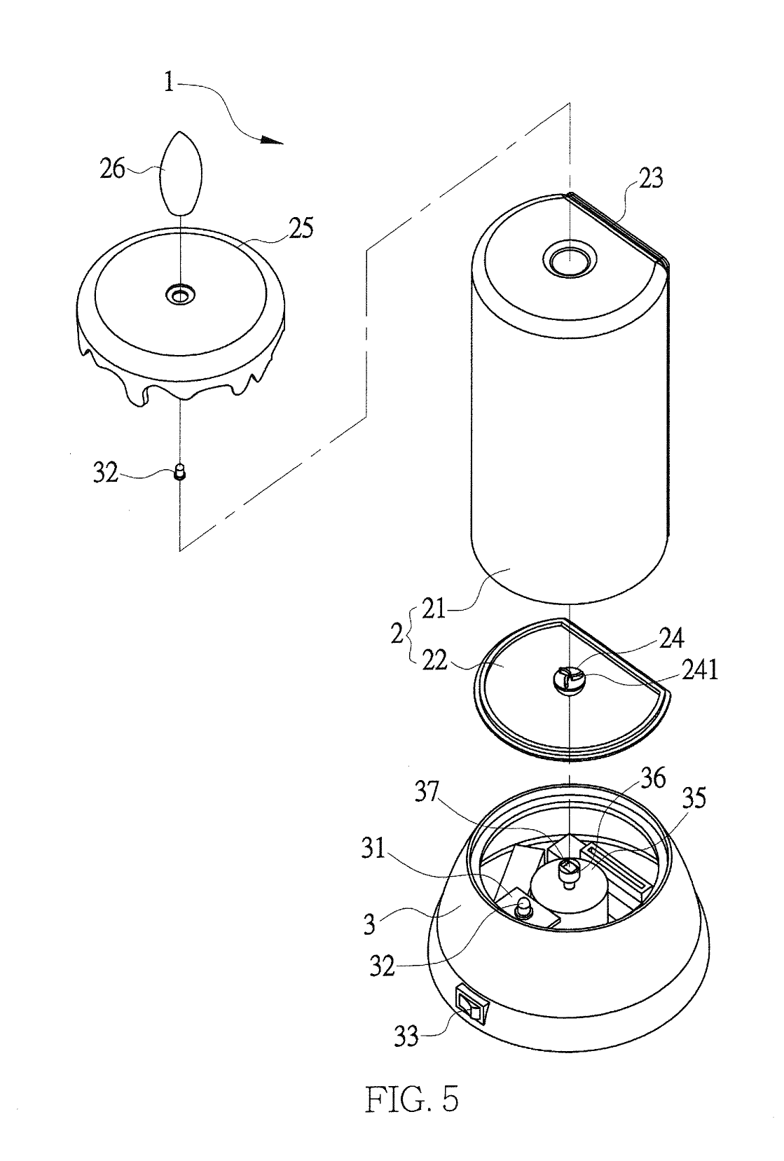

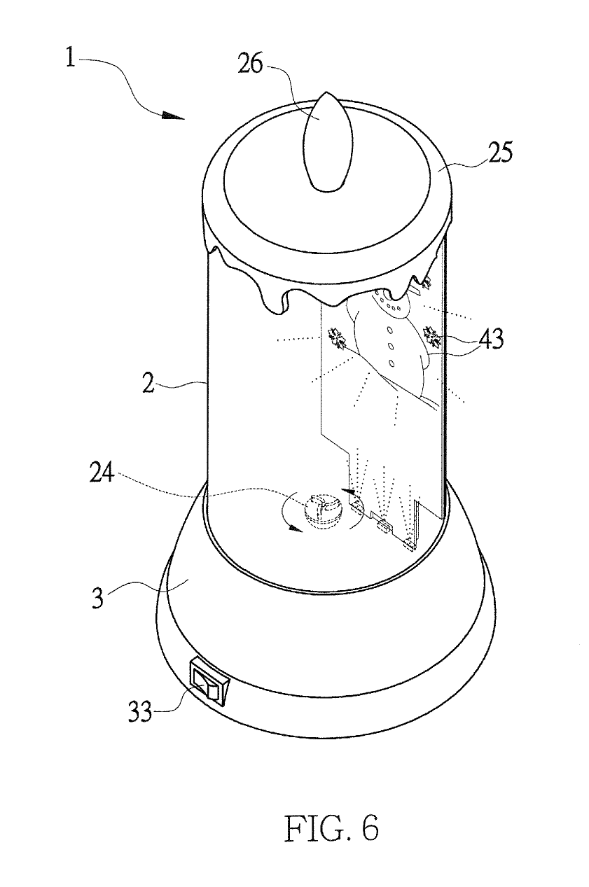

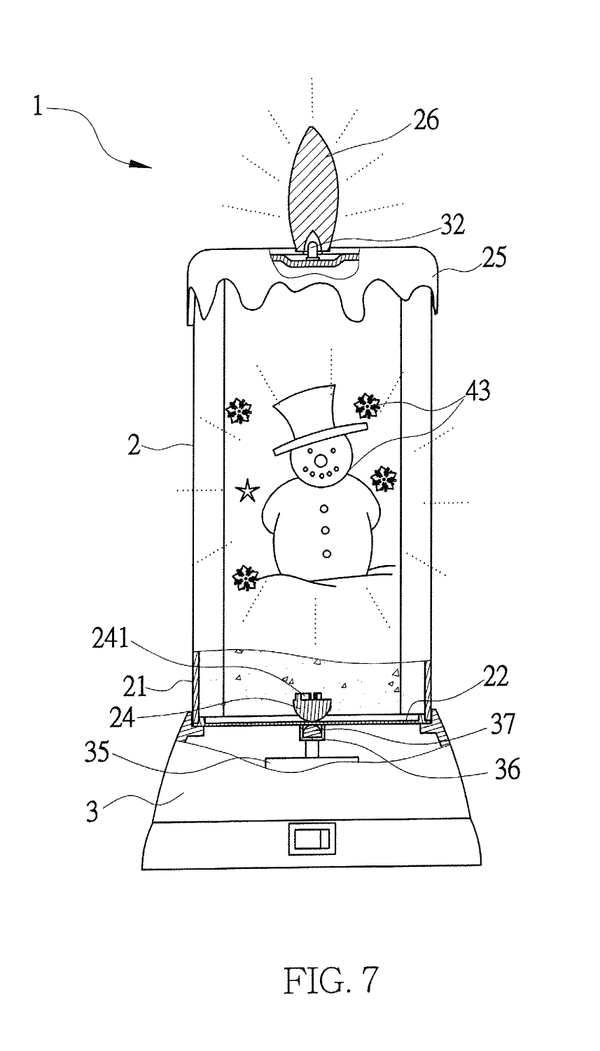

Next, referring to FIGS. 5 to 7, the base seat 3 had a magnetic rotating shaft 36, which is driven by a power member 35 to rotate. In the present embodiment, the power member 35 is a motor, and the magnetic rotating shaft 36 is extended from the motor. Furthermore, a magnetic element 37 is configured on the top end of the magnetic rotating shaft 36, and the electric power of the power member 35 come from a correspondingly assembled battery or an AC, DC power supply. But, the variable patterns of power sources are rather too many, and not the features claimed by the present invention; the details thereof are omitted here.

Furthermore, a hemispheric poking member 24 is further configured inside the main body 2, and a plurality of radiating poking plates 241 on the top of the poking element 24; the poking member 24 is attracted by magnetic rotating shaft 36 magnetically to rotate therewith. Furthermore, an outer decorative body 25 is further configured on the top of the main body 2, and has a lampshade 26 inside which an light-emitting element 32 in electric connection with the control circuit 31 is configured, where the light-emitting element 32 is fixed on the top of the main body 2, and the outer decorative body 25 takes the shape of dripping wax, thereby allowing the present invention to form a simulative candle outlook.

Here, when the base seat 3 is switched on, the magnetic rotating shaft 36 is driven to rotate, and then attracts the poking member 24 magnetically to rotate, and further to stir the fluid inside the main body 2 to flow. Thereupon, the flowing of the fluid and the illumination of the light-emitting elements together with the illumination of the light-emitting element 32 of the outer decorative body 25 allow the present invention to have a double visual effect of dynamics and lighting.

I claim:

1. A back-lighted twinling candle, comprising:
a main body, being hollow and pervious-to-light, flowable fluid and a poking member being mounted inside said main body hermetically, and one side of said main body having a planar surface portion;
a base seat, configured below said main body, configured with a control circuit and at least on light-emitting element in electric connect with said control circuit correspondingly to a bottom of said main body, and a magnetic rotating shaft driven by a power member to rotate, said magnetic rotating shaft attracting said poking member magnetically to rotate; and
a graph card unit, comprising a pervious-to-light first light guiding sheet stacked on said planar surface portion of said main body, said first guiding sheet having a preset texture, a light guiding portion corresponding to said light-emitting element.

2. The candle according to claim 1, wherein said first light guiding sheet is stacked on an inner side of said planar surface portion.

3. The candle according to claim 1, wherein said first light guiding sheet is stacked on an outer side of said planar surface portion.

4. The candle according to claim 1, wherein said graph card unit further comprises a second light guiding stacked on one side of said first light guiding sheet, said second light guiding sheet has a preset texture corresponding to said first light guiding sheet and a light input portion; a light-emitting element is configured on said base seat correspondingly to said light input portion of said second light guiding sheet.

5. The candle according to claim 1, further comprising an outer decorative body configured on a top of said main body, said outer decorative body having a lampshade, and a light-emitting element in electric connection with said control circuit being configured inside said lampshade.

6. The candle according to claim 1, wherein a switch in electric connection with said control circuit is configured on said base seat.
